(19) United States
(12) Patent Application Publication
(10) Pub. No.: US 2006/0088163 A1
(43) Pub. Date: Apr. 27, 2006

(54) Integrated circuit capable of pre-descrambling a portion of a frame

(76) Inventor: Richard D. Carmichael, Phoenix, AZ (US)

Correspondence Address: Grossman, Tucker, Perreault & Pfleger, PLLC;PortfolioIP, P.O. Box 52050, Minneapolis, MN, 55402, US

(21) Appl. No.: 10/972,841

(22) Filed: Oct. 25, 2004

(51) Int. Cl. H04N 7/167

(52) U.S. Cl. 380/210

(57) ABSTRACT

A method according to one embodiment may include receiving a frame comprising scrambled data, identifying a portion of the scrambled data, descrambling the portion to obtain descrambled data associated with the portion; and evaluating the descrambled data and providing a result of the evaluating operation before completion of descrambling of all of the scrambled data of the frame. Of course, many alternatives, variations, and modifications are possible without departing from this embodiment.

### FIELD

This disclosure relates to an integrated circuit capable of pre-descrambling a portion of frame.

### BACKGROUND

A conventional data storage system may include one device capable of bidirectional communication with another device. One device may include a computer node having a host bus adapter (HBA). The other device may be mass storage. Each may function as a sending and receiving device in order to exchange data and/or commands with each other using one or more of a variety of communication protocols. Typically, the communication protocol defines various frame types and associated maximum frame lengths. The communication protocol may also require scrambling of data before transmission. Such scrambling may be implemented to minimize repetitive character patterns.

The receiving device may receive and process a received frame having such scrambled data. Processing the received frame may include a frame validation process including checking if the frame type is supported and checking the length of the frame. However, in a conventional embodiment such fame validation process occurs after full descrambling of all the scrambled data in the frame. In addition, the results of the frame validation process are presented to an associated queue after the writing of data in the frame to the associated queue. The data in the queue may then be transferred to memory via direct memory access (DMA) methods. Hence, if the frame validation process reveals an error, the data already in the queue would need to utilize a flush feature to isolate and discard the data. In addition given the order in which the data and status information is provided to the queue, a complex receive processor and queue is required to provide for complex data and status reordering in the queue before presenting such data and status indicators to be stored in memory via DMA

### BRIEF DESCRIPTION OF THE DRAWINGS

Features and advantages of embodiments of the claimed subject matter will become apparent as the following Detailed Description proceeds, and upon reference to the Drawings, where like numerals depict like parts, and in which:

FIG. 1 is a diagram illustrating a system embodiment;

FIG. 2 is a diagram illustrating in greater detail an integrated circuit in the system embodiment of FIG. 1;

FIG. 3 is a flow chart illustrating operations of the integrated circuit of FIG. 2;

FIG. 4 is a diagram illustrating in greater detail another embodiment of the integrated circuit in the system of FIG. 1; and

FIG. 5 is a flow chart illustrating operations that may be performed according to an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly.

### DETAILED DESCRIPTION

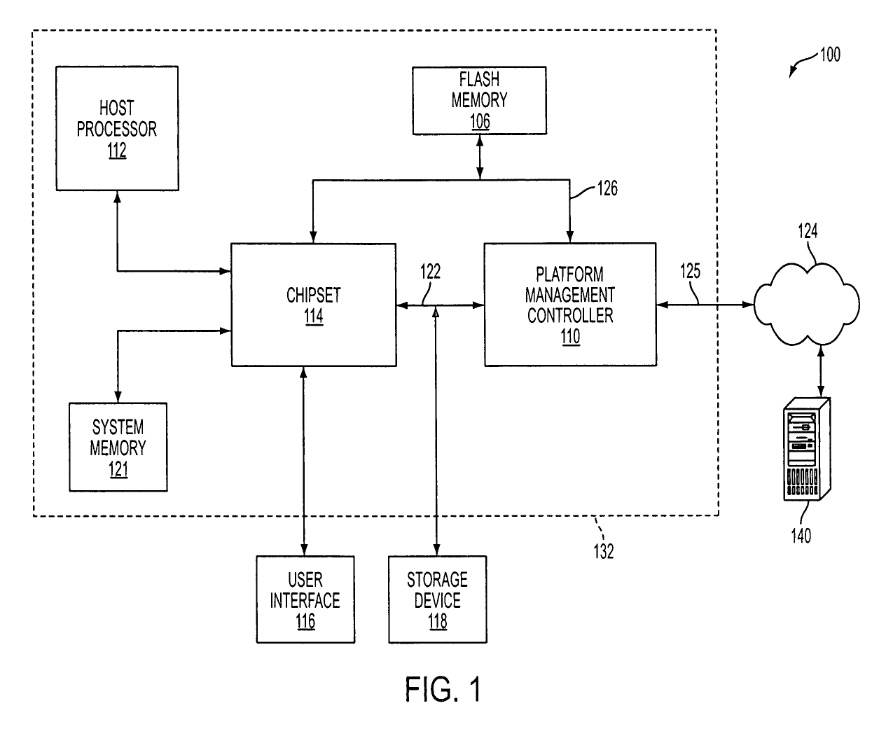

FIG. 1 illustrates a system 100 consistent with an embodiment including a computer node having a host bus adapter (HBA), e.g., circuit card 120. The circuit card 120 may be capable of bidirectional communication with mass storage 104 via one or more communication links 106 using one or more communication protocols. Mass storage 104 may include one or more mass storage devices, e.g., one or more redundant array of independent disks (RAID) and/or peripheral devices.

Communication between the HBA 120 and mass storage 104 may take place by transmission of one or more frames. As used herein in any embodiment, a “frame” may comprise one or more symbols and/or values. Both the HBA 120 and mass storage 104 may act as a receiving device that receives data and/or commands from the other. The HBA 120 may have an integrated circuit 140 having frame validation circuitry 160 capable of performing frame validation checks on received frames. As used herein, an “integrated circuit” means a semiconductor device and/or microelectronic device, such as, for example, a semiconductor integrated circuit chip. As used herein, “circuitry” may comprise, for example, singly or in any combination, hardwired circuitry, programmable circuitry, state machine circuitry, and/or firmware that stores instructions executed by programmable circuitry.

The system 100 may also generally include a host processor 112, a bus 122, a user interface system 116, a chipset 114, system memory 121, a circuit card slot 130, and a circuit card 120 capable of communicating with mass storage 104. The host processor 112 may include one or more processors known in the art such as an Intel® Pentium® IV processor and/or an XScale® architecture processor commercially available from the Assignee of the subject application. The bus 122 may include various bus types to transfer data and commands. For instance, the bus 122 may comply with the Peripheral Component Interconnect (PCI) Express™ Base Specification Revision 1.0, published Jul. 22, 2002, available from the PCI Special Interest Group, Portland, Oreg., U.S.A. (hereinafter referred to as a “PCI Express™ bus”). The bus 122 may alternatively comply with the PCI-X Specification Rev. 1.0a, Jul. 24, 2000, available from the aforesaid PCI Special Interest Group, Portland, Oreg., U.S.A. (hereinafter referred to as a “PCI-X bus”).

The user interface system 116 may include one or more devices for a human user to input commands and/or data and/or to monitor the system 100 such as, for example, a keyboard, pointing device, and/or video display. The chipset 114 may include a host bridge/hub system (not shown) that couples the processor 112, system memory 121, and user interface system 116 to each other and to the bus 122. Chipset 114 may include one or more integrated circuit chips, such as those selected from integrated circuit chipsets commercially available from the assignee of the subject application (e.g., graphics memory and I/O controller hub chipsets), although other integrated circuit chips may also, or alternatively be used. The chipset 114 and processor 112 may be coupled through an XSI interface. The XSI interface may include a 64-bit, high performance bus designed to interconnect to XScale® architecture processors. The processor 112, system memory 121, chipset 114, bus 122, and circuit card slot 130 may be on one circuit board 132 such as a system motherboard.

The circuit card 120 may be constructed to permit it to be inserted into the circuit card slot 130. When the circuit card 120 is properly inserted into the slot 130, connectors 134 and 137 become electrically and mechanically coupled to each other. When connectors 134 and 137 are so coupled to each other, the card 120 becomes electrically coupled to bus 122 and may exchange data and/or commands with system memory 121, host processor 112, and/or user interface system 116 via bus 122 and chipset 114.

Alternatively, without departing from this embodiment, the operative circuitry of the circuit card 120 may be included in other structures, systems, and/or devices. These other structures, systems, and/or devices may be, for example, in the motherboard 132, and coupled to the bus 122. These other structures, systems, and/or devices may also be, for example, comprised in chipset 114.

The circuit card 120 may communicate with mass storage 104 via one or more communication links 106 using one or more communication protocols. Exemplary communication protocols may include Fibre Channel (FC), Serial Advanced Technology Attachment (S-ATA), and/or Serial Attached Small Computer Systems Interface (SAS) protocol. If a FC protocol is used by circuit card 120 to exchange data and/or commands with mass storage 104, it may comply or be compatible with the interface/protocol described in ANSI Standard Fibre Channel Framing and Signaling Interface Specification, 2 Rev 0.3 T11/1619-D, dated Sep. 7, 2004. Alternatively, if a S-ATA protocol is used by circuit card 120 to exchange data and/or commands with mass storage 104, it may comply or be compatible with the protocol described in “Serial ATA: High Speed Serialized AT Attachment,” Revision 1.0a, published on Jan. 7, 2003 by the Serial ATA Working Group, and the Extension to SATA, 1.0a Rev 1.2, dated Aug. 27, 2004. Further alternatively, if a SAS protocol is used by circuit card 120 to exchange data and/or commands with mass storage 104, it may comply or be compatible with the protocol described in “Information Technology—Serial Attached SCSI—1.1 (SAS),” Working Draft American National Standard of International Committee For Information Technology Standards (INCITS) T10 Technical Committee, Project T10/1562-D, Revision 6, published Oct. 2, 2004, by American National Standards Institute (hereinafter termed the “SAS Standard”) and/or later-published versions of the SAS Standard.

To accomplish such communication using any variety of communication protocols such as SAS, S-ATA, and FC protocols, the circuit card 120 may have protocol engine circuitry 150. The protocol engine circuitry 150 may exchange data and commands with mass storage 104 by transmission and reception of one or more frames, e.g., frames 170a, 170b. A large number of frames from many different devices such as mass storage devices and HBAs may be transmitted via communication links 106. The protocol engine circuitry 150 may be included in an integrated circuit 140. The protocol engine circuitry 150 may include various layers such as a transport layer circuitry. Such transport layer circuitry may support Serial Advanced Technology Attachment (ATA) Tunneled Protocol (STP) layer circuitry.

The integrated circuit 140 may also comprise memory 138. Memory 138 may comprise one or more of the following types of memories: semiconductor firmware memory, programmable memory, non-volatile memory, read only memory, electrically programmable memory, random access memory, flash memory, magnetic disk memory, and/or optical disk memory.

Machine readable firmware program instructions may be stored in memory 138. These instructions may be accessed and executed by the integrated circuit 140. When executed by the integrated circuit 140, these instructions may result in the integrated circuit 140 performing the operations described herein as being performed by the integrated circuit.

The IC 140 may comprise frame validation circuitry 160 to validate received frames, e.g., frames 170a, 170b. Mass storage 104 may also include frame validation circuitry 162 operable to validate received frames. Such frame validation circuitry 160, 162 may be included in the protocol engine circuitry 150, 152 as illustrated in FIG. 1 or, alternatively, may be stand alone circuitry or included in other circuitry.

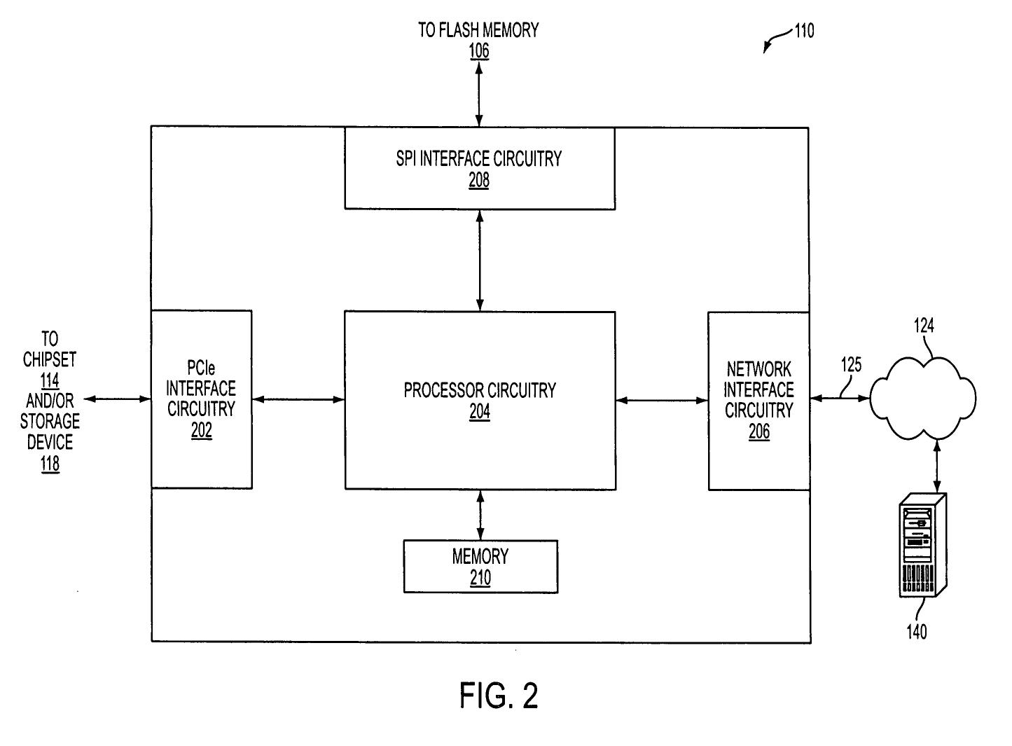

FIG. 2 illustrates one embodiment 160a of the frame validation circuitry 160 comprised in the IC 140 of FIG. 1 to receive and process a received frame 170a. A plurality of received frames may be received via communication links 106. The frame may be of a variety of formats depending, at least in part, on the communication protocol utilized. An exemplary S-ATA compliant frame 170a having scrambled data is illustrated. The S-ATA compliant frame may include a start of frame (SOF) primitive 250 to indicate the start of the frame 170a. A “primitive” as used herein may be defined as a group of one or more symbols, for example, representing control data to facilitate control of the transfer of information and/or to provide real time status information. One or more other primitives 252 and 254, e.g., an ALIGN primitive, may follow the SOF primitive 250.

A frame header 258 may follow the SOF primitive 250 (again with other allowed primitives 252 and 254 perhaps dispersed there between). The frame header 258 may contain a first non-primitive Dword 256 occurring after the SOF primitive 250. This Dword 256 may contain scrambled data. As used herein, a Dword may contain four bytes or thirty two bits of data. This first non-primitive Dword 256 may contain data indicating the type of the frame information structure (FIS) 260 and expected length of the FIS 260, e.g., the first four bytes of this first non-primitive Dword 256 may be representative the FIS type, expected length of the FIS 260, and other FIS attributes such as an error field for DMA setup.

The FIS 260 may follow the frame header 258. This FIS data may also be scrambled. As used herein, the “FIS” may be defined as a portion of the frame that comprises payload. The length of the FIS 260 may be based on the specified FIS type as may be detailed in the first non-primitive Dword 256. An error checking code may follow the FIS 260. An error checking code may include a cyclic redundancy check (CRC) 262 to facilitate checking of the validity of the received data in the FIS 258. Finally, an end of frame (EOF) primitive 264 may follow the CRC 262 to mark the end of the frame 170a.

In general, the frame validation circuitry 160a may receive and process a frame, e.g., frame 170a. The frame validation circuitry may include “look-ahead” circuitry 202, a receive processor 204, an output queue 206, and descrambling circuitry 208. Look-ahead circuitry 202 may further include detection circuitry 210 and descrambling circuitry 214. Although the look-ahead circuitry 202 is described herein relative to the frame validation circuitry 160a, the look-up circuitry may also be utilized for other functions, e.g., to quickly determine whether or not a potential SAS command queuing interlock potential exists.

The receive processor 204 of the frame validation circuitry 160a may include various logic and state machines to perform a variety of functions. The receive processor 204 may further include data count circuitry 210 and error checking circuitry 212.

As a frame 170a including scrambled data is received by the frame validation circuitry 160a, the detection circuitry 216 may search for and detect the first non-primitive Dword 256 of the frame 170a. Such detection may be made by recognizing the SOF primitive 250 and any other allowed primitives 252, 254 and accepting the first non-primitive Dword there after. As earlier detailed, such first non-primitive Dword may include data representative of the type of the FIS 260 and the expected length of the FIS 260 as well as other frame attributes. The first non-primitive Dword may be scrambled.

The descrambling circuitry 214 of the look-ahead circuitry 202 may descramble this Dword and provide descrambled data to the receive processor 204. The descrambling circuitry 214 may perform such descrambling by exclusive OR'ing the scrambled data with a constant. The descrambling circuitry 214 may mimic the first Dword result of a full data descrambler operating on deterministically manipulated bits and bytes. As such, the descrambling circuitry 214 may provide descrambled data to the receive processor. Such descrambled data may contain data representative of the type of the frame and the expected length of the frame, both of which may be utilized by the receive processor 204 to start processing the frame 170a early.

Upon receiving data representative of the frame type from the look-ahead circuitry 202, the receive processor 204 may check if that frame type is a supported frame type. The receive processor 204 may do this by comparing the received frame type against a stored list of acceptable frame types. If such frame type is not supported, the receive processor 204 may direct the associated frame to be immediately discarded without writing any data from such frame to the queue 206. The receive processor 204 may then provide an error status signal to the queue 206. Such error status signal may then trigger the associated receiving device to send a reception error primitive (R_ERR) back to the transmitting device waiting for a reception status reply.

If the frame type is supported, the receive processor 204 may provide a status signal representative of such condition to the output queue 206. Therefore the look-ahead circuitry 202 enables the receive processor 202 to check the validity of the frame type without waiting for full descrambling of all data in the FIS 260 which would be performed by descrambling circuitry 208. Unsupported frame types may therefore be quickly identified and discarded. Hence, unnecessary operations (full descrambling, CRC checking) may be avoided and bad FIS data does not have to be flushed from the queue 206 since the FIS data associated with the invalid FIS type was discarded before being written to the queue 206.

The data count circuitry 210 is responsive to the received FIS 260 to count length units of the received FIS. The length units may be units such as bytes, bits, or Dwords. Primitives that may be dispersed within the FIS 260 would not be counted by, for example, not advancing a counter in the data count circuitry 210 for such primitives. Various types of S-ATA compliant frames may have an expected length specified in Dwords. For example, a Register—Host to Device frame type defined by the S-ATA protocol may define a length of that FIS type as five Dwords. Once the FIS is received, the receive processor 204 may utilize the results of the data count from the data count circuitry 210 and compare that data count with the expected frame length that was obtained earlier from the look-ahead circuitry 202.

If the data count is not equal to the expected length of the frame, the receive processor 204 may direct the associated frame to be immediately discarded without writing any data from such frame to the queue 206. The receive processor 204 may then provide an error status signal to the queue 206 which may also trigger the associated receiving device to send a reception error primitive back to the transmitting device waiting for a reception status reply.

If the data count is equal to the expected length, the receive processor 204 may provide a status signal representative of such condition to the output queue 206. Therefore the look-ahead circuitry 202 enables the receive processor 202 to check the count data of the frame without waiting for full descrambling of all data in the FIS 260 which would be performed by descrambling circuitry 208. Frame types with incorrect data counts may therefore be quickly identified and discarded after receipt of the FIS 260. Hence, unnecessary operations (full descrambling, CRC checking) may be avoided and FIS data does not have to be flushed from the queue 206 since the invalid FIS count was determined and the frame discarded before any FIS data was written to the queue 206.

If the early evaluation processes (e.g., frame type and length determinations) are acceptable, such status may be written to the queue 206 and full descrambling 208 may take place. Error checking utilizing error checking circuitry 212 may also then take place. The error checking circuitry 212, e.g., CRC checking circuitry, may receive both the CRC 262 and the FIS 260 from the frame 170a. The error checking circuitry 212 may apply the same mathematical calculation to the received FIS that was performed on the transmitted FIS, e.g., this may be a 16 bit polynomial calculation. The error checking circuitry 212 may then compare the result of its calculation based on the received FIS with the result of the calculation applied on the transmitted FIS as indicated in the CRC 262. If the CRC 262 and the result match, then the FIS data is determined to have been sent successfully. If they do not agree, then the error checking circuitry 212 determines that there is an error in the received FIS.

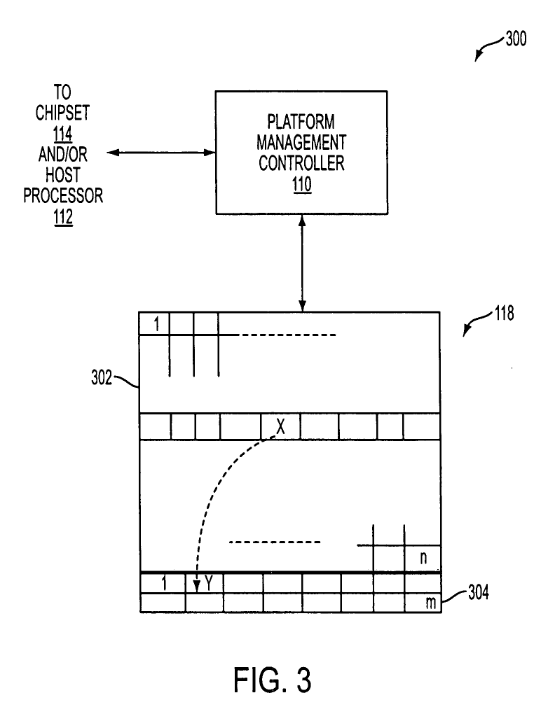

FIG. 3 is a flow chart 300 of operations that may be performed by frame validation circuitry 160a (FIG. 2) of the IC 140. As such, reference may be made to particular circuitry of FIG. 2. However, the operations 300 may be performed using software, firmware, hardware, or some combination thereof. In operation 302, a frame having scrambled data is received, e.g., frame 170a. Operation 304 detects a portion of the frame such as the first non-primitive Dword 256. Operation 306 then descrambles the scrambled data detected in operation 304. This may be accomplished by descrambling circuitry 214. The output of operation 306 may include data representative of the type of frame and the expected length of the frame.

Operation 308 may then determine if the frame type is supported. This operation 308 may be performed by the receive processor 204. If not supported, the frame may be discarded 310. A reception error signal may also be sent back to the transmitting device by the receiving device if the frame is discarded. As such, a frame having an invalid frame type may not be written to the queue 206 and therefore later flushing of the frame from the queue may be avoided. If the frame type is supported, a status signal representative of such condition may be output at time t1 during operation 312. Such status signal may be output to the queue 206.

Meanwhile, operation 314 may perform byte and bit manipulation on the received frame. Operation 316 may count payload data of the frame, e.g., the FIS 260. Operation 318 may then compare count data from operation 316 with an expected length of the frame from operation 306. If the count data is not equal to the expected length, the frame may be discarded in operation 320. A reception error signal may also be sent back to the transmitting device by the receiving device if the frame is discarded. If the count data is equal to the expected count data, a status signal representative of such condition may be output in operation 322 at time t2. Time t2 of operation 322 may occur after time t1 of operation 312. Both these status signals from operations 312 and 322 may be considered to be part of a start of frame status signal.

Full descrambling of all the data in the FIS 260 may then occur during operation 324. This may be accomplished by descrambling circuitry 208. An error checking operation 326 may then be performed utilizing the descrambled FIS data. Such operation 326 may be performed by error checking circuitry 212. If the error checking result is not acceptable, then the frame may be discarded in operation 328. Again, a reception error signal may also be sent back to the transmitting device by the receiving device if the frame is discarded and the frame may also be discarded before any FIS data is written to the queue 206.

If the error checking result is acceptable, descrambled FIS data may then be written to the queue 206 at time t3 during operation 330. Time t3 of operation 330 may occur after time t2 of operation 322, which itself may occur after time t1 of operation 312. Finally, an end of frame (EOF) status signal may be provided to the queue at time t4 during operation 332. Time t4 may occur after time t3. The EOF status signal may include the results of the CRC check and other end of frame checks. Hence, the need for complex reordering of data and status words in the output queue 206 that occurs in a conventional embodiment may be simplified and even eliminated by the operations 300 of FIG. 3.

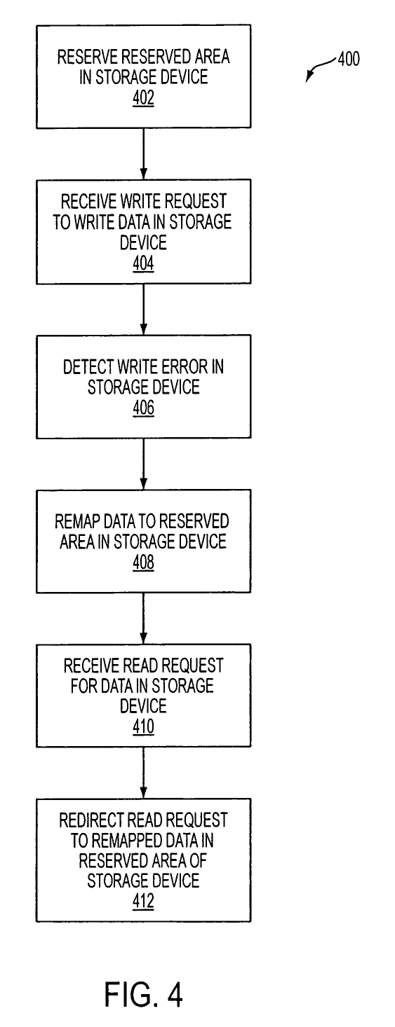

FIG. 4 illustrates another embodiment 160b of the frame validation circuitry 160 of the IC 140 of FIG. 1 to receive and process a received frame, e.g., frame 170a. The frame validation circuitry may include look-ahead circuitry 402, receive processor 404, descrambling circuitry 408, and an output queue 406. The look-ahead circuitry 402 may include descrambling circuitry 414 that descrambles the first non-primitive Dword of the received frame, e.g., by exclusive OR'ing the scrambled data with a constant. This may then result in a descrambled Dword which may be part of the FIS header 415.

Descrambling circuitry 408 may include descrambling circuitry 409 for data Dwords and circuitry 411 for primitive Dwords. The primitive descrambler circuitry 411 is illustrated for illustration purposes only referencing the SAS Standard as the receive processor 404 may discard primitives. Byte swapping may occur for both data Dwords and primitive Dwords of the scrambled data to result in a scrambled data Dword 421 and primitive Dword 423. A multiplexer (MUX) 427 may combine descrambled data Dwords and primitive Dwords.

Basic operation of the frame control circuitry 160b of FIG. 4 is otherwise consistent with the frame control circuitry 160a of FIG. 2 and operations 300 described with reference to FIG. 3. Hence, any repetitive descriptions are omitted herein for clarity.

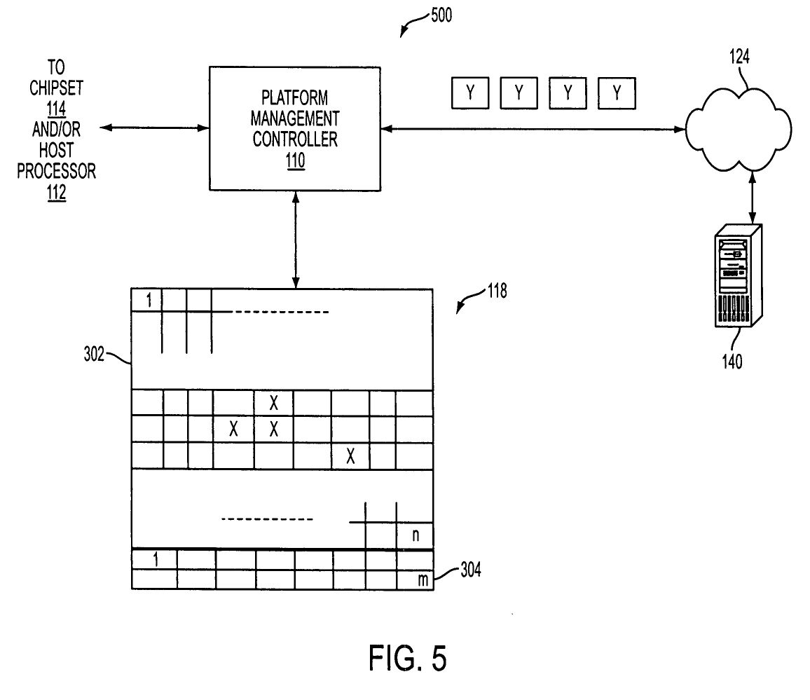

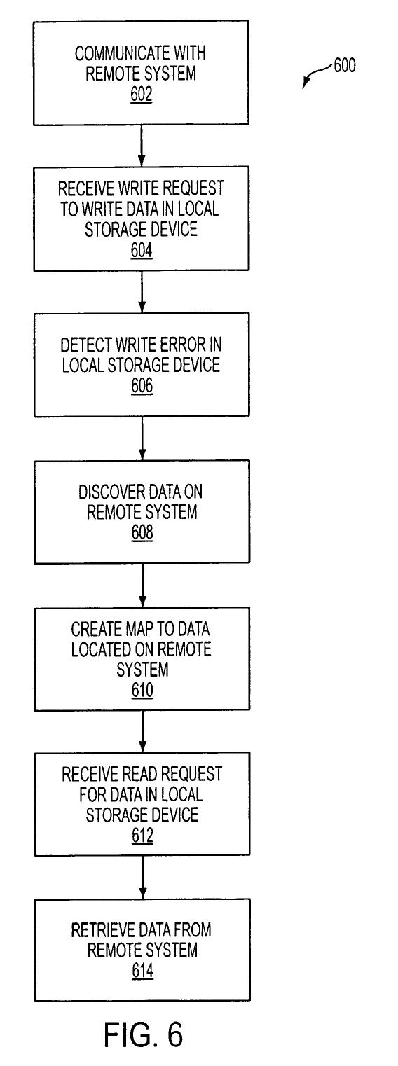

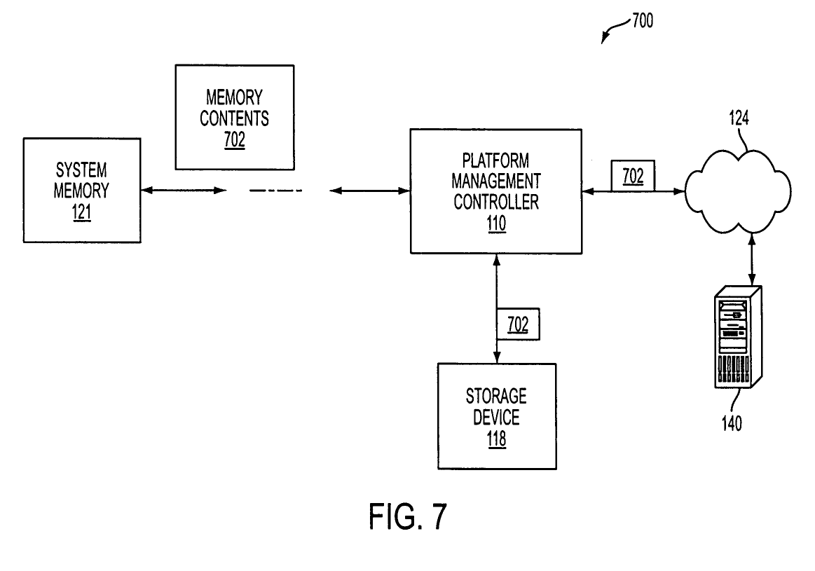

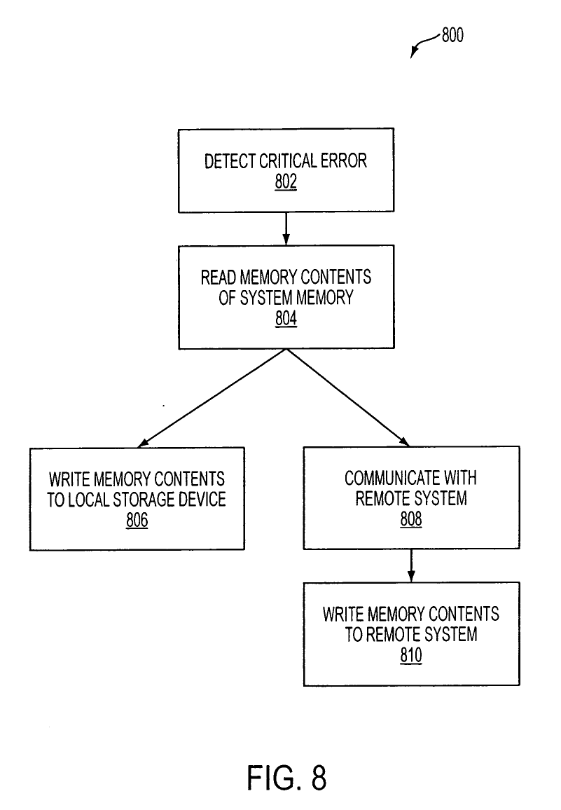

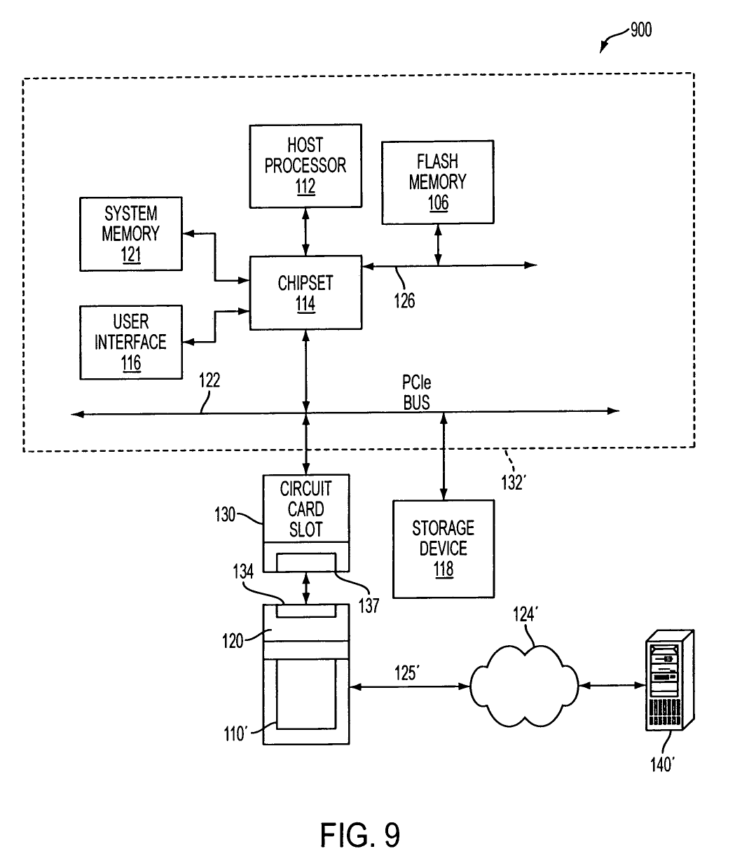

FIG. 5 is a flow chart of operations 500 consistent with an embodiment. Operation 502 may include identifying a portion of a received frame, where the received frame and the portion comprise scrambled data. For example, this may be frame 170a as illustrated in FIG. 2. Operation 504 may include descrambling the scrambled data of the portion to obtain descrambled data. In one embodiment, this portion may include the first non-primitive Dword 256 of the frame. Finally, operation 508 includes evaluating the descrambled data and providing a result of the evaluating operation before completion of descrambling of all of said scrambled data of the frame.

It will be appreciated that the functionality described for all the embodiments described herein may be implemented using hardware, firmware, software, or a combination thereof.

Thus, in summary, one embodiment may comprise an article. The article may comprise a storage medium having stored therein instructions that when executed by a machine result in the following: identifying a portion of a received frame, the received frame and the portion comprising scrambled data; descrambling the scrambled data of the portion to obtain descrambled data; and evaluating the descrambled data and providing a result of the evaluating operation before completion of descrambling of all of the scrambled data of said frame.

Another embodiment may comprise an apparatus. The apparatus may comprise an integrated circuit, e.g., integrated circuit 140. The integrated circuit may be capable of identifying a portion of a received frame where the received frame and the portion comprise scrambled data. The integrated circuit may be further capable of descrambling the scrambled data of the portion to obtain descrambled data. The integrated circuit may be further capable of evaluating the descrambled data and providing a result of the evaluating operation before completion of descrambling of all of the scrambled data of said frame.

A system embodiment may include a circuit card comprising an integrated circuit. The circuit card may be capable of being coupled to a bus. The integrated circuit may be capable of identifying a portion of a received frame where the received frame and the portion comprise scrambled data. The integrated circuit may be further capable of descrambling the scrambled data of the portion to obtain descrambled data. Finally, the integrated circuit may be further capable of evaluating the descrambled data and providing a result of the evaluating operation before completion of descrambling of all of the scrambled data of said frame.

Advantageously, in these embodiments, a result of the evaluating operation on the descrambled data, e.g., of the first non-primitive Dword in one embodiment, is provided, e.g., to the output queue 206, before completion of descrambling of all of said scrambled data of the frame. If the result of the evaluating operation is negative, then the associated frame may be discarded without being written to the output queue. Therefore, later flushing of FIS data may be avoided. In addition, completing the evaluating operation (e.g., checking if the frame type is supported and/or checking the length of the frame in one instance) and providing the results before descrambling of all of the data ensures that the results are provided, e.g., to the output queue, before the descrambled FIS is provided to the output queue. Therefore, complex reordering of status information and FIS data in the output queue is minimized if not eliminated. Hence, the output queue may be greatly simplified compared to a conventional output queue. In addition, the receive processor 204 may also be greatly simplified since its reordering functions are simplified. Hence, DMA to memory from the queue completion occurs faster than a conventional embodiment.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. A method comprising:
identifying a portion of a received frame, said received frame and said portion comprising scrambled data;
descrambling said scrambled data of said portion to obtain descrambled data; and
evaluating said descrambled data and providing a result of said evaluating operation before completion of descrambling of all of said scrambled data of said frame.

2. The method of claim 1, wherein said descrambled data comprises data representative of a type of said frame, and said evaluating operation comprises checking if said type of said frame is supported.

3. The method of claim 2, further comprising discarding said frame if said type of said frame is not supported.

4. The method of claim 1, wherein said descrambled data comprises data representative of an expected length of said frame, and said evaluating operation comprises counting payload data of said frame and comparing count data from said counting operation with said expected length of said frame.

5. The method of claim 4, further comprising discarding said frame if said count data is different than said expected length of said frame.

6. The method of claim 1, wherein said frame comprises a primitive representative of a start of said frame, and said identifying operation comprises identifying a non-primitive Dword, said non-primitive Dword being a first non-primitive Dword after said primitive representative of said start of said frame.

7. An article comprising:
a storage medium having stored therein instructions that when executed by a machine result in the following:
identifying a portion of a received frame, said received frame and said portion comprising scrambled data;
descrambling said scrambled data of said portion to obtain descrambled data; and
evaluating said descrambled data and providing a result of said evaluating operation before completion of descrambling of all of said scrambled data of said frame.

8. The article of claim 7, wherein said descrambled data comprises data representative of a type of said frame, and said evaluating operation comprises checking if said type of said frame is supported.

9. The article of claim 8, wherein said instructions that when executed by said machine also result in discarding said frame if said type of said frame is not supported.

10. The article of claim 7, wherein said descrambled data comprises data representative of an expected length of said frame, and said evaluating operation comprises counting payload data of said frame and comparing count data from said counting operation with said expected length of said frame.

11. The article of claim 10, wherein said instructions that when executed by said machine also result in discarding said frame if said count data is different than said expected length of said frame.

12. The article of claim 7, wherein said frame comprises a primitive representative of a start of said frame, and said identifying operation comprises identifying a non-primitive Dword, said non-primitive Dword being a first non-primitive Dword after said primitive representative of said start of said frame.

13. An apparatus comprising:
an integrated circuit capable of identifying a portion of a received frame, said received frame and said portion comprising scrambled data, said integrated circuit further capable of descrambling said scrambled data of said portion to obtain descrambled data, and said integrated circuit further capable of evaluating said descrambled data and providing a result of said evaluating operation before completion of descrambling of all of said scrambled data of said frame.

14. The apparatus of claim 13, wherein said descrambled data comprises data representative of a type of said frame, and wherein said integrated circuit capable of evaluating said descrambled data comprises checking if said type of said frame is supported.

15. The apparatus of claim 14, wherein said integrated circuit is further capable of discarding said frame if said type of said frame is not supported.

16. The apparatus of claim 13, wherein said descrambled data comprises data representative of an expected length of said frame, and wherein said integrated circuit capable of evaluating said descrambled data comprises counting payload data of said frame and comparing count data from said counting operation with said expected length of said frame.

17. The apparatus of claim 16, wherein said integrated circuit is further capable of discarding said frame if said count data is different than said expected length of said frame.

18. The apparatus of claim 13, wherein said frame comprises a primitive representative of a start of said frame, and said integrated circuit capable of identifying said portion of said scrambled data comprises identifying a non-primitive Dword, said non-primitive Dword being a first non-primitive Dword after said primitive representative of said start of said frame.

19. A system comprising:
a circuit card comprising an integrated circuit, said circuit card capable of being coupled to a bus, said integrated circuit capable of identifying a portion of a received frame, said received frame and said portion comprising scrambled data, said integrated circuit further capable of descrambling said scrambled data of said portion to obtain descrambled data, and said integrated circuit further capable of evaluating said descrambled data and providing a result of said evaluating operation before completion of descrambling of all of said scrambled data of said frame.

20. The system of claim 19 further comprising a circuit board comprising said bus and a bus interface slot, said circuit card capable of being coupled to said bus interface slot.

21. The system of claim 19, wherein said descrambled data comprises data representative of a type of said frame, and wherein said integrated circuit capable of evaluating said descrambled data comprises checking if said type of said frame is supported.

22. The system of claim 21, wherein said integrated circuit is further capable of discarding said frame if said type of said frame is not supported.

23. The system of claim 19, wherein said descrambled data comprises data representative of an expected length of said frame, and wherein said integrated circuit capable of evaluating said descrambled data comprises counting payload data of said frame and comparing count data from said counting operation with said expected length of said frame.

24. The system of claim 23, wherein said integrated circuit is further capable of discarding said frame if said count data is different than said expected length of said frame.

25. The system of claim 19, wherein said frame comprises a primitive representative of a start of said frame, and said integrated circuit capable of identifying said portion of said scrambled data comprises identifying a non-primitive Dword, said non-primitive Dword being a first non-primitive Dword after said primitive representative of said start of said frame.
